(19) United States
(12) Patent Application Publication
(10) Pub. No.: US 2007/0189428 A1
(43) Pub. Date: Aug. 16, 2007

(54) Method and system for automatically calibrating a clock oscillator in a base station

(76) Inventors: Barry F. Knerr, Wheaton, IL (US); Charles D. Gavrilovich, Park Ridge, IL (US)

Correspondence Address: MOTOROLA, INC., 1303 EAST ALGONQUIN ROAD, IL01/3RD, SCHAUMBURG, IL, 60196, US

(21) Appl. No.: 11/353,702

(22) Filed: Feb. 14, 2006

(51) Int. Cl. H04L 7/00

(52) U.S. Cl. 375/354

(57) ABSTRACT

Method and system for automatically calibrating a clock oscillator (202) in a base station (102) are provided. The method (300) includes receiving (304) a span of at least one transmission link and linking (306) the base station to at least one reference clock over the at least one transmission link. Further, the method includes receiving (308) a reference signal from the at least one reference clock through the at least one transmission link. The method also includes synchronizing (310) the clock oscillator with the reference signal within a calibration period of a specified duration.

### FIELD OF THE INVENTION

This invention relates in general to base stations in a communication network, and more specifically, to a method and system for automatically calibrating a clock oscillator in a base station.

### BACKGROUND OF THE INVENTION

A base station plays an important role in a wireless communication network. The base station enables mobile devices, for example, mobile phones and personal digital assistants (PDA), in the wireless communication network to communicate with each other. It is desirable that a base station functions in a predetermined frequency range so that the base station can effectively transfer data with mobile devices and other base stations. Each of the base stations and mobile devices operate within the same known predetermined frequency range. Deviation of the base station from the predetermined frequency range can result in disturbance in the call, error in data traffic and in may also result in dropping of calls because the base stations and mobile devices will no longer be able to transfer data. In order to maintain any predetermined frequency range, devices within a wireless communication network are provided with a clock oscillator. Some examples of the clock oscillator include an Oven Controlled Crystal Oscillator (OXCO), a Rubidium Crystal Oscillator (RbXO), and a Voltage Controlled Crystal Oscillator (VCXO). As can be appreciated by those of skill in the art, clock oscillators have given losses over time.

To prevent a network device including the base station from deviating from the predetermined frequency range, a clock oscillator within the base station needs to be calibrated. For this purpose, the clock oscillator can be synchronized with a reference signal received from a reference clock. There are various methods for calibrating a clock oscillator. According to one such method, the clock oscillator is calibrated manually for a predetermined time interval by using external test equipment. The method requires a manual visit to the base station each time the clock oscillator needs to be calibrated. An employee of a wireless communication network operator is required to physically visit the base station. At the location, the base station is physically connected to a reference clock and the clock oscillator is synchronized to the reference clock. The visit to the base incurs a predetermined cost. Since there can be thousands of base stations in a wireless communication network, this method can be expensive. Secondly, there is no remote access to the clock oscillator of the base station. If the clock oscillator drifts outside the predetermined frequency range between scheduled calibration visits, a supplemental visit is therefore required, which incurs additional expenses.

In another method, the base station is continuously calibrated with a reference signal. In this method, a link is formed between the base station and a reference clock, which provides the reference signal to the base station. As one of ordinary skill in the art understands, there are certain loss and wander components inherent in the link between the base station and the reference clock. Accordingly, the link is continually monitored for loss and wander components and these components are taken into consideration as the clock oscillator is being synchronized. It is possible that the clock oscillator is synchronized continually with the reference signal and modifications for loss and wander are made. It is also possible that the clock oscillator is synchronized periodically during the continual connection when it is deemed to be the best time in consideration of the loss and wander components.

In view of the foregoing, a method and system of calibrating a clock oscillator is needed where the clock oscillator is accessed remotely while overcoming the losses and wander characteristics imposed by the remote reference clock being accessed over transmission links.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages, all in accordance with the present invention:

FIG. 1 is block diagram illustrating a wireless communication network, in which various embodiments of the present invention can be practiced;

FIG. 2 illustrates a base station, in accordance with an embodiment of the present invention;

FIG. 3 is a flow diagram illustrating a method for automatically calibrating a clock oscillator in a base station, in accordance with an embodiment of the present invention; and

FIG. 4 is a flow diagram illustrating a method for automatically calibrating a clock oscillator in a base station, in accordance with another embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail the particular method and system for automatically calibrating a clock oscillator in a base station in accordance with various embodiments of the present invention, it should be observed that the present invention resides primarily in combinations of method steps and apparatus components related to automatic calibration of a clock oscillator in a base station. Accordingly, the apparatus components and method steps have been represented, where appropriate, by conventional symbols in the drawings, showing only those specific details that are pertinent to understanding the present invention, so as not to obscure the disclosure with details that will be readily apparent to those of ordinary skill in the art having the benefit of the description herein.

In this document, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element. The terms “includes” and/or “having”, as used herein, are defined as comprising.

In an embodiment, a method for automatically calibrating a clock oscillator in a base station is provided. The method includes receiving a span of at least one transmission link. The span links the base station to at least one reference clock. Further, the method includes linking the base station to the at least one reference clock over the at least one transmission link. The method also includes receiving a reference signal from at least one reference clock through at least one transmission link. Moreover, the method includes synchronizing the clock oscillator to the reference signal within a calibration period of a specified.

In another embodiment, a base station is provided. The base station includes a clock oscillator and a control unit. The control unit automatically calibrates the clock oscillator with a reference signal from a reference clock within a calibration period of a specified duration. The control unit receives a span. The base station is linked to the reference signal over the span of transmission links.

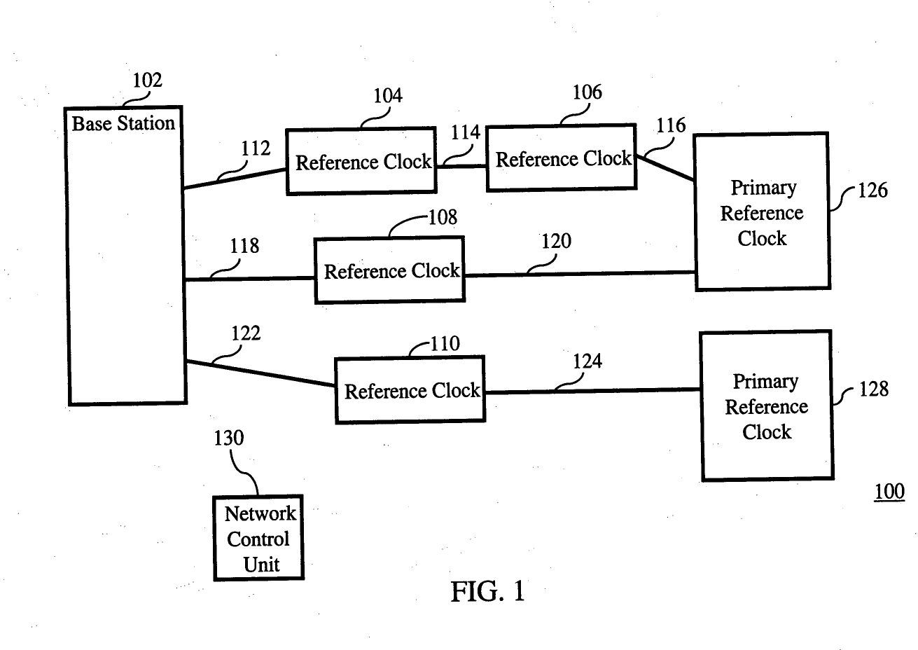

FIG. 1 is block diagram illustrating a wireless communication network 100, in which various embodiments of the present invention can be practiced. The wireless communication network 100 includes a base station 102. The base station 102 enables mobile devices, for example, mobile phones and Personal Digital Assistants (PDAs) in the wireless communication network 100 to communicate with each other. The wireless communication network 100 further includes one or more reference clocks and primary reference clocks. Examples of these one or more reference clocks and primary reference clocks include, but are not limited to, a cesium atomic clock and a Global Positioning System (GPS) reference clock. The reference clock can be located within the network, as in the case of a cesium atomic clock, or readily accessible by the network, as in the case of a GPS reference clock. For the purpose of this description, the wireless communication network 100 is shown to include a reference clock 104, a reference clock 106, a reference clock 108, and a reference clock 110. As will be appreciated by those of skill in the art, one of the reference clocks 104-110 may be a primary reference clock and the remaining reference clocks may be calibrated to the primary reference clock. In such a case, the calibrated reference clocks may be able to provide a time and frequency reference for a device within the wireless communication network 100, but may not be suitable to calibrate the clock oscillator for the base station 102 such that the clock oscillator is calibrated to be within the predetermined frequency range. For the purpose of this description, the wireless communication network 100 is shown to include a primary reference clock 126 and a primary reference clock 128. Each reference clock of the one or more reference clocks is synchronized with a primary reference clock of the one or more primary reference clocks. For example, the reference clock 108 is synchronized with the primary reference clock 126.

The base station 102 can be connected to the at least one reference clock 104-110 or one or more primary reference clocks 126-128 through one or more transmission links. Examples of the one or more transmission links include, but are not limited to, a coaxial cable, a fiber-optic cable, and a twisted-pair cable. In addition, a wireless transmission link is possible, but for the purposes of the current invention hardwired transmission links reduce losses, noise and wander between network devices. For the purpose of this description, the wireless communication network 100 is shown to include at least a transmission link 112, a transmission link 114, a transmission link 116, a transmission link 118, a transmission link 120, a transmission link 122, and a transmission link 124. These transmission links can be used to transmit a reference signal from a reference clock to a base station, in order to synchronize a clock oscillator in the base station. For example, the clock oscillator can be synchronized with a reference signal received over the transmission link 112 from the reference clock 104.

In an embodiment of the present invention, the network control unit 130 can be included. The network control unit 130 communicates with base station 102 and other devices within the wireless communication network 100 and provides data for the operation of the base station 102 and the other network devices. The network control unit 130 may be a base station controller or other network device that provides network control. As will be demonstrated in more detail below, the network control unit 130 can provide the base station 102 the transmission links 112-124 to access the reference clocks 104-110 and the primary reference clock 126-128.

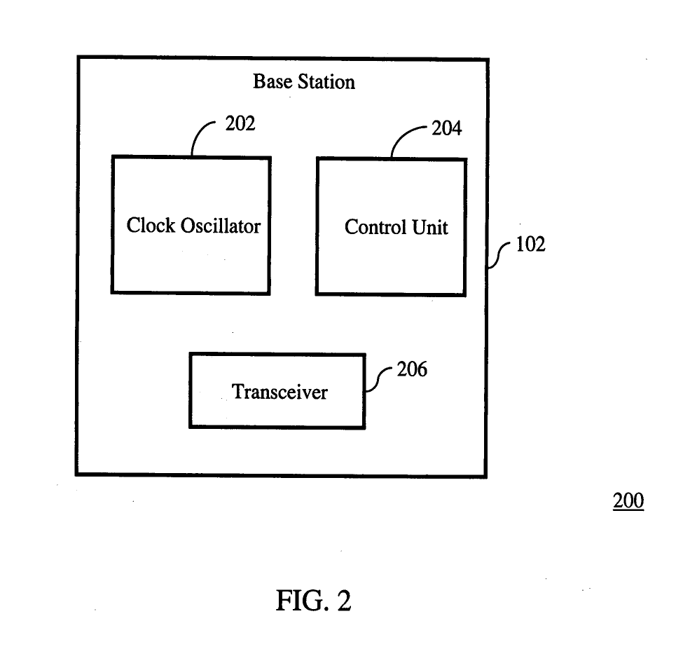

FIG. 2 illustrates a base station 102, in accordance with an embodiment of the present invention. The base station 102 includes a clock oscillator 202, a control unit 204, and a transceiver 206. Examples of the clock oscillator 202 include, but are not limited to, an Oven Controlled Crystal Oscillator (OXCO), Rubidium Crystal Oscillator (RbXO), and a Voltage-controlled Crystal Oscillator (VCXO). The clock oscillator 202 is used by the base station 102 as the frequency source for the base station 102. Thus, is the clock oscillator 202 that needs to periodically be calibrated with a reference signal so that the signals of the base station 102 can be maintained within the predetermined frequency range thus effectuating communications amongst base stations and mobile devices within the wireless communication network 100.

The control unit 204 is configured to operate the base station 102. In the context of the present invention, the control unit 204 operates to, among other things, automatically calibrate the clock oscillator 202 to a reference signal from a reference clock, for example, the reference clock 104 or primary reference clock 126. The transceiver 206 is provided for the base station 102 to send and receive signals to mobile devices, other base stations, the network control unit 130 and other devices within and for the operation of the wireless communication network 100. As will be explained in more details below, the base station 102 needs to know how to connect to the reference clock 104-110 or the primary reference clock 126-128 using the transmission links 112-124, and the transceiver 206 receives the span of transmission links from the network control unit 130.

To determine the span, the network control unit 130, or the other device that is determining the span of transmission links, also determines where to obtain the reference signal to which the base station 102 will be calibrated. In one embodiment, the network control unit 130 selects one of the primary reference clocks 126-128 to supply the reference signal. Referring back to FIG. 1, the network control unit 130 can determine a span comprising transmission links 112-116, which go through reference clocks 104-106, or can determine a span comprising transmission links 112-120 through reference clock 108 to get to primary reference clock 126. The network control unit 130 can also determine a span comprising transmission links 122-124 through reference clock 110 to get to primary reference clock 128. Alternatively, the network control unit 130 can determine a span that links the base station 102 with a reference clock 104-110 to supply the reference signal.

The span chosen depends on a number of factors. When choosing one of the reference clocks, the network control unit 130 examines the paths between a reference clock and a primary reference clock to determine if the wander and loss components of the reference clock are sufficient to be used for the reference signal. The path from a reference clock 104-110 must be traceable to the primary reference signal with an accuracy of approximately 0.01 parts per billion. The span should be selected with a minimum number of clocks to the primary reference clock. The network control unit 130 can also verify that the reference clocks between the base station 102 and the selected reference signal are synchronized to a master clock and are not in hold over or free running. If they are free running mode, then there is an increased likelihood that the reference clock is not within the predetermined frequency range. During calibration, the selected span can be taken out of service so that an accurate reference signal is received. If the selected span is not taken out of service, the calibration signal will be extracted from the traffic signal sent over the span.

Further, the control unit 204 receives a span of transmission links, which links the base station with the reference signal supplied by the reference clock or the primary reference clock. The span of transmission links can be determined by the network control unit 130 or other suitable network device including the base station 102. In order to determine the span of transmission links, the network control unit 130 scans the network for the reference clocks 104-110 and the primary reference clocks 126-128 to determine which of these clocks will provide an acceptable reference signal and where the span between the reference signal and the base station 102 minimizes losses and wander components for the reference signal. In an embodiment, the span has wander components of 18 microseconds (μs) at the upper end of an acceptable range. Wander components of less then 18 μs are therefore sought in determining an appropriate span. Wander may be composed of 1 μs due to environmental effects, 2 μs due to asynchronous mapping and up to approximately 15 μs caused by clock noise and transients. As the number of transmission links between the base station 102 and the reference signal decrease the wander components may decrease. In addition, the type of transmission links used, e.g. fiber cables, also reduces the wander components. Thus, it is possible to have a wander component of less then 3 μs and less then 1 μs if the span uses one highly efficient transmission link. Examples of wander components that contribute to the wander value include, but are not limited to, clock noise, environment noise, and asynchronous mapping.

The network control unit 130 calculates the span between the base station 102 and various reference signals and determines which span has the least wander components for reference signal. The span should also not have a history or many outages, frequent failure alarms or frequent maintenance calls. This selected span is provided to the base station 102. In an embodiment, a transmission link is asynchronously mapped, for example, when electronic devices connected to the transmission link function in the different frequency ranges. In an embodiment, the span is an overhead transmission link. In another embodiment, the span can be underground.

The network control unit 130 can examine both the wander components and calibration periods together to determine the span and the calibration period. Accordingly, the span is determined such that the wander components are kept to a minimum during a sufficiently short calibration period. In one embodiment, a calibration period of approximately 15 minutes can be determined when the wander components contributed by the span to the reference signal is approximately 18 μs and be acceptable.

The calibration period is a specific duration of time during which the clock oscillator 202 is calibrated to the reference clock or the primary reference clock. The calibration period can be calculated by the base station 102 or by the network control unit 130 and is received by the base station 102 with the span. The calibration period is calculated and determined to be that period of time that is necessary for the clock oscillator 202 to be properly calibrated by the reference signal given the various factors including, but not limited to, the losses and wander factors of the span connecting the base station to the reference clock or the primary reference clock. With a short calibration period, the probability that the span signal will become inaccurate is minimized. In addition, the calibration period is sufficiently long enough so that any security measures, checks with the reference clock and the primary reference clock, confirmations that the calibration is completed and recalibrations can be conducted.

In an embodiment, the calibration period can be as long as 12 hours. This provides sufficiently long enough period for the base station 102 to calibrate the clock oscillator 202 and for all checks, confirmations and recalibrations to be completed. A calibration period of 15 minutes or less can also be used to perform the necessary tasks to properly calibrate and confirm calibration of the clock oscillator 202. In addition, the calibration period can be any period between that minimum time needed for calibration and one that is sufficiently long to complete the process while not overloading wireless communication network resources, base station resources and reference clock or the primary reference clocks. During the calibration period, the base station 102 may not running in its typical free run mode because it is connected to the reference clock or the primary reference clock. At the completion of the calibration period, the base station 102 can be returned to free running mode such that the clock oscillator 202 provides a signal within the predetermined frequency range without any assistance from another clock source and the clock oscillator 202 is able to wander from the predetermined frequency range.

After receiving the span of transmission links and the control unit knows the calibration period, the control unit 204 connects the base station 102 with the reference clock or the primary reference clock. The control unit 204 can then automatically calibrates the clock oscillator 202 to a reference signal from the reference clock 104-110 or a primary reference clock 126, 128 within a calibration period of a specified duration.

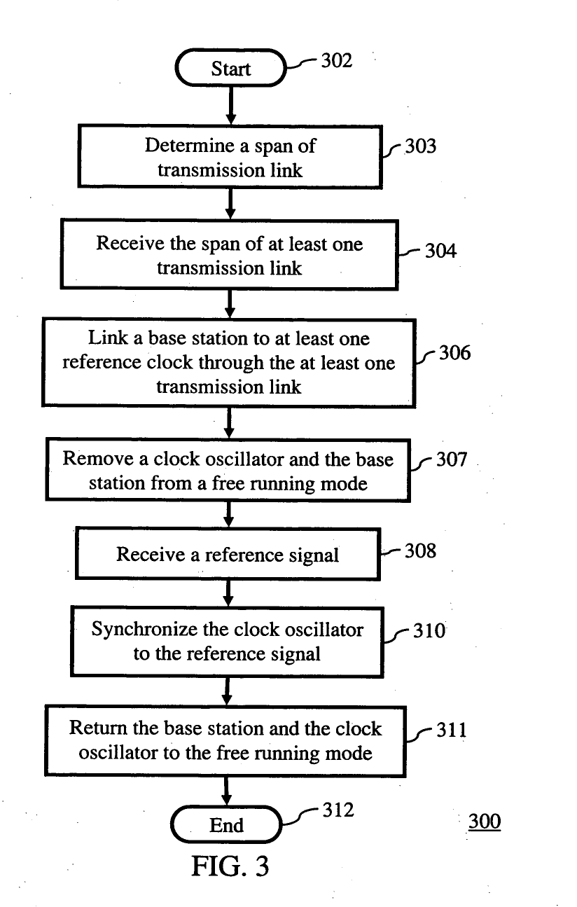

FIG. 3 is a flow diagram 300 for automatically calibrating the clock oscillator 202 in the base station 102, in accordance with an embodiment of the present invention. After initiating the process at step 302, a span of transmission links between the base station 102 and a reference clock or a primary reference clock that will supply the reference signal to the base station 102 is determined at step 303. During step 303, it is also determined if the reference signal is going to be obtained from a reference clock or a primary reference clock. With this decision, the appropriate span can be derived by the network control unit 130 or other network device including the base station 102. Furthermore, the calibration period is calculated. The span and calibration period are determined depending on numerous factors including the wander components.

After step 303, the base station 102 receives over the transceiver 206 the span of at least one transmission link, the source of the reference signal and the calibration period at step 304. For example, the base station 102 can receive a span with transmission links 112, 114, and 116. The span links the base station 102 to the primary reference clock 126. In addition, the base station 102 can receive a calibration period of 15 minutes. In an embodiment, the span has a maximum wander value of 18 microseconds (μs). Examples of wander components that contribute to the wander value include, but are not limited to, clock noise, environment noise, and asynchronous mapping. After the span is received, a transmission link from the at least one transmission link is selected. In an embodiment, a transmission link with the shortest length among the at least one transmission link is selected. In another embodiment, a transmission link with a synchronous mapping with at least one primary reference clock is selected. At step 306, the base station 102 is linked to one of the at least one transmission link received in the span. For example, the base station 102 may be linked to the reference clock 104 over the transmission link 112 or the primary reference clock 126 over the transmission links 112-116. In an embodiment, the at least one transmission link is traceable to the at least one primary reference clock through a predefined number of reference clocks. For example, the transmission link 116 is traceable to the primary reference clock 126 through a minimum number of reference clocks, for example, zero reference clocks.

At step 307, the base station 102 and the clock oscillator 202 are removed from being in free running mode. In an alternative embodiment, the base station 102 and clock oscillator 202 remain in free running mode, but during synchronization described below, the traffic signal over the span is used. Returning to FIG. 3 the base station 102 receives a reference signal from the selected reference clock over the span and through the at least one transmission link at step 308. For example, the base station 102 can receive the reference signal from the reference clock 104 through the transmission link 112 or primary reference clock 126 over transmission links 112-116.

At step 310, the clock oscillator 202 in the base station 102 is synchronized with the reference signal. The clock oscillator 202 is synchronized with the reference signal within a calibration period of a specified duration. In an embodiment, the calibration period is within a range between 15 minutes and 12 hours. In an embodiment, the calibration period is less than 2 hours. In an embodiment, the calibration is performed when the temperature is stable, for example, in the morning hours. In an embodiment, the clock oscillator 202 is set in a free running mode after it is synchronized with the reference signal. In the free running mode, the clock oscillator 202 does not receive the reference signal. Thereafter, the base station 102 and the clock oscillator 202 return to the free running mode at step 311. The process terminates at the step 312.

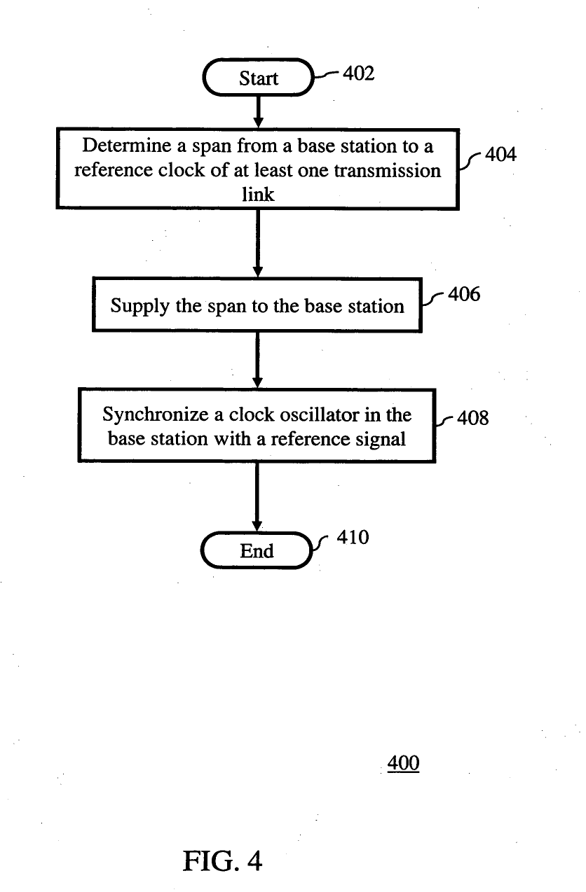

FIG. 4 is a flow diagram 400 for automatically calibrating the clock oscillator 202 in the base station 102, in accordance with another embodiment of the present invention. After initiating the process at step 402, a span from the base station 102 to the reference clock is determined at step 404. The span can be determined by the network control unit 130 or the base station 102. The span includes at least one transmission link. In an embodiment, the transmission link is traceable to at least one of a cesium atomic clock and a GPS reference clock. In an embodiment, the span has a maximum wander value of 18 microseconds (μs). Examples of wander components that contribute to the wander value include, but are not limited to, clock noise, environment noise, and asynchronous mapping. At step 406, the span is supplied to the base station 102. The span links the base station 102 to the reference clock over the at least one transmission link. At step 408, the clock oscillator 202 is synchronized with the reference signal from the reference clock during a calibration period of a specified duration. Thereafter, the process terminates at the step 410.

Various embodiments of the present invention provide a method and system for automatically calibrating a clock oscillator in a base station. This eliminates the need for manual calibration of the clock oscillator. As a result, the cost incurred by a client visit at the base station is eliminated. Further, the clock oscillator is set in a free running mode after the calibration is completed. This insures that the base station is not continuously synchronized with a reference signal, since the reference signal can drift from its specifications once the calibration of the clock oscillator is completed.

It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method of automatically calibrating a clock oscillator in a base station, the method comprising:
receiving a span of at least one transmission link wherein the span links the base station to at least one reference clock;
linking the base station to the at least one reference clock over the at least one transmission link;
receiving a reference signal from the at least one reference clock through the at least one transmission link; and
synchronizing the clock oscillator with the reference signal within a calibration period of a specified duration.

2. The method of claim 1 further comprising setting the clock oscillator in a free running mode.

3. The method of claim 1, wherein the span has a minimum wander value for the calibration period to be approximately 15 minutes.

4. The method of claim 4, wherein the span has a maximum wander value of 18 (microsecond) μs.

5. The method of claim 1, wherein the at least one reference clock is one of a cesium atomic clock and a global positioning system reference clock.

6. The method of claim 4, wherein the at least one transmission link is traceable to at least one primary reference clock through a predefined number of reference clocks.

7. The method of claim 1 further comprising selecting the at least one transmission link with predefined wander components, wherein the wander components are selected from a group comprising clock noise, environmental noise, and asynchronous mapping.

8. The method of claim 1 further comprising selecting a transmission link having a synchronous mapping with at least one primary reference clock.

9. The method of claim 1, wherein the calibration period is less than 2 hours.

10. The method of claim 1 wherein the calibration period is less than 15 minutes.

11. A method of calibrating a clock oscillator in a base station, the method comprising:
determining a span from the base station to a reference clock wherein the span includes at least one transmission link; and
supplying the span to the base station wherein the base station links to the reference clock over the at least one transmission link; and
synchronizing the clock oscillator with a reference signal from the reference clock within a calibration period of a specified duration.

12. The method of claim 10, wherein the base station runs in a free running mode after the calibration period is completed.

13. The method of claim 10, wherein the at least one transmission link is traceable to at least one of a cesium atomic clock and a global positioning system reference clock.

14. The method of claim 10, wherein the at least one transmission link has predefined wander components, wherein the wander components are selected from a group comprising clock noise, environmental noise, and asynchronous mapping.

15. The method of claim 10, wherein the calibration period is less than 15 minutes.

16. The method of claim 10, wherein the span has a maximum wander value of 18 microseconds (μs).

17. A base station comprising:
a clock oscillator; and
a control unit capable of automatically calibrating the clock oscillator to a reference signal from a reference clock wherein the base station links to the reference signal over a span of transmission links wherein the span is received by the control unit and the calibration is performed within a calibration period of a specified duration.

18. The base station of claim 17, wherein the span has a maximum wander value of 18 microseconds (μs).

19. The base station of claim 17, wherein the calibration period is within a range between 15 minutes and 12 hours.

20. The base station of claim 17, wherein the base station runs in a free running mode after the calibration period is completed.
